(19) United States
(12) Patent Application Publication
(10) Pub. No.: US 2018/0339256 A1
(43) Pub. Date: Nov. 29, 2018

(54) ANTENNA, COVERING MEMBER, AND EXHAUST PURIFICATION DEVICE

(71) Applicant: FUJITSU LIMITED, Kawasaki-shi (JP)

(72) Inventors: Masato Nishimori, Machida (JP); Tadahiro Imada, Kawasaki (JP)

(73) Assignee: FUJITSU LIMITED, Kawasaki-shi (JP)

(21) Appl. No.: 15/987,130

(22) Filed: May 23, 2018

(30) Foreign Application Priority Data
May 25, 2017 (JP) 2017-103901

(51) Int. Cl. B01D 46/00; H01Q 1/32; B01J 23/42; G01N 15/08

(52) U.S. Cl. CPC B01D 46/0061; H01Q 1/325; B01D 46/0086; B01J 23/42; G01N 22/00; B01D 2273/22; B01D 2279/30; G01N 2015/084; G01N 15/08

(57) ABSTRACT

An antenna including an antenna electrode that transmits or receives microwaves, and a covering layer that supports an oxidation catalyst, that is formed from an inorganic material, and that covers the antenna electrode.

### CROSS-REFERENCE TO RELATED APPLICATION

This application is based upon and claims the benefit of priority of the prior Japanese Patent Application No. 2017-103901, filed on May 25, 2017, the entire contents of which are incorporated herein by reference.

### FIELD

Technology disclosed herein relates to an antenna, a covering member, and an exhaust purification device.

### BACKGROUND

Generally, internal combustion engine vehicles are provided with an exhaust purification device that purifies exhaust produced by the internal combustion engine. These exhaust purification devices include a casing inside which exhaust flows, and a filter provided inside the casing. Fine particles contained in the exhaust are captured by a filter in the exhaust purification device, thereby purifying the exhaust.

With such an exhaust purification device, filter performance tends to decrease as the amount of fine particles captured at the filter increases. Thus, technology has been proposed that regenerates the filter by burning off the fine particles captured at the filter.

Methods for determining the timing at which to regenerate a filter include methods that detect the amount of fine particles captured at the filter. The following technologies are examples of such methods for detecting the amount of fine particles captured at the filter (for example, see Patent Document 1).

Namely, in such technology, a transmitting antenna and a receiving antenna are provided inside the casing of the exhaust purification device. The transmitting antenna transmits microwaves toward the filter, and the receiving antenna receives the microwaves transmitted through the filter. The amount of fine particles captured at the filter is detected based on a difference between the strength of the microwaves transmitted from the transmitting antenna and the strength of microwaves received by the receiving antenna.

### Related Patent Documents

Patent Document 1: Japanese National Phase Publication No. 2012-507660

Patent Document 2: Japanese Laid-Open Patent Publication No. 2001-289779

Patent Document 3: Japanese Laid-Open Patent Publication No. 2011-128002

### SUMMARY

According to an aspect of the embodiments, an apparatus includes an antenna including an antenna electrode that transmits or receives microwaves, and a covering layer that supports an oxidation catalyst, that is formed from an inorganic material, and that covers the antenna electrode.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a side view of a vehicle to which an exhaust purification device according to a first exemplary embodiment has been mounted.

FIG. 2 is a side view cross-section of the exhaust purification device illustrated in FIG. 1.

FIG. 3 is a two-plane view (side view and bottom view) of the antenna illustrated in FIG. 2.

FIG. 4 is an enlarged side view cross-section of relevant portions of the antenna illustrated in FIG. 3.

FIG. 5 is a side view of an antenna according to a second exemplary embodiment.

FIG. 6 is an enlarged side view cross-section of relevant portions of the antenna illustrated in FIG. 5.

FIG. 7 is a side view of an antenna according to a third exemplary embodiment.

FIG. 8 is an enlarged side view cross-section of relevant portions of the antenna illustrated in FIG. 7.

FIG. 9 is a side view of an antenna according to a fourth exemplary embodiment.

### DESCRIPTION OF EMBODIMENTS

### First Exemplary Embodiment

Explanation will first be given regarding a first exemplary embodiment of technology disclosed herein.

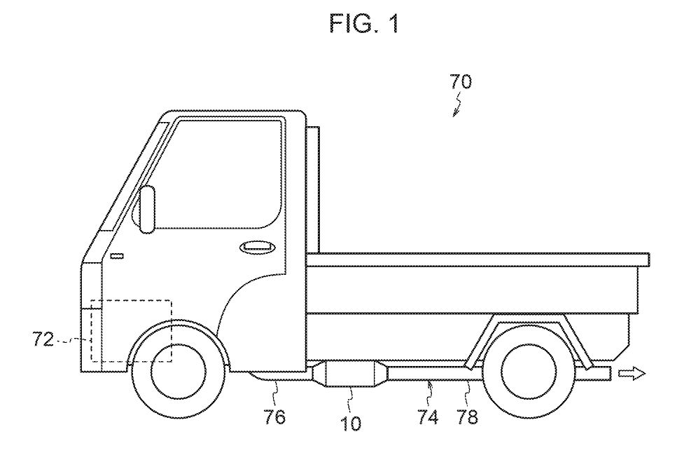

FIG. 1 illustrates a vehicle 70 to which an exhaust purification device 10 according to the first exemplary embodiment has been mounted. The vehicle 70 illustrated in FIG. 1 is, for example, a truck, and includes a diesel internal combustion engine 72. The internal combustion engine 72 is connected to exhaust pipe members 74. Exhaust from the internal combustion engine 72 passes through the exhaust pipe members 74 and is discharged to the outside. The exhaust purification device 10 according to the first exemplary embodiment is provided at a length direction central portion of the exhaust pipe members 74.

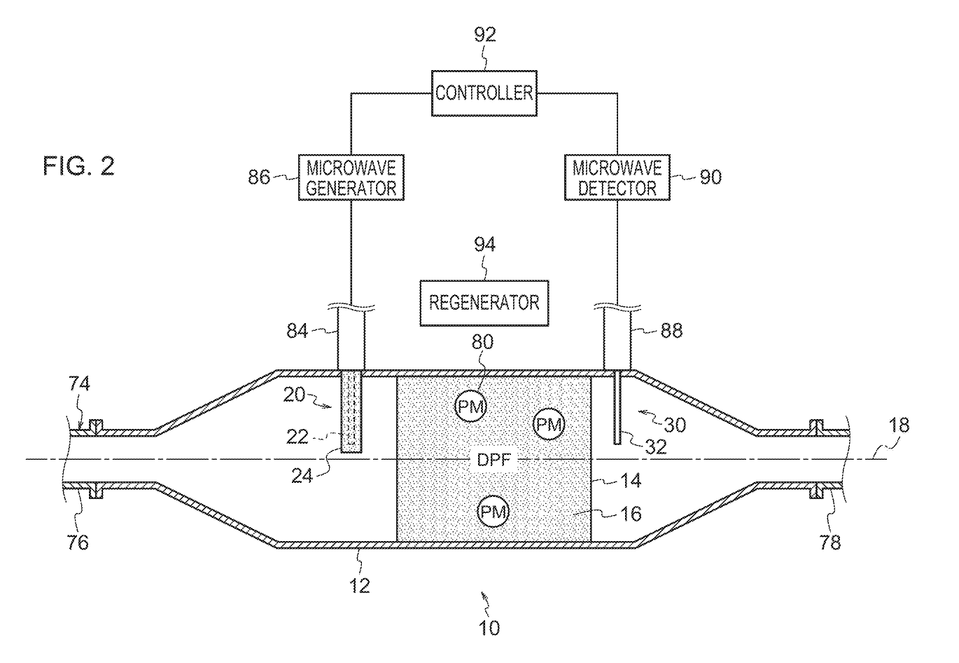

FIG. 2 is a side view cross-section illustrating the exhaust purification device 10 according to the first exemplary embodiment. As illustrated in FIG. 2, the exhaust purification device 10 includes a casing 12, a filter 14, a transmitting antenna 20, and a receiving antenna 30.

The casing 12 is made of metal, and is formed with a tubular shape or a box shape. Of the exhaust pipe members 74, an upstream pipe 76 is connected to the intake-side of the casing 12. Further, of the exhaust pipe members 74, a downstream pipe 78 is connected to the exhaust-side of the casing 12. Exhaust from the internal combustion engine 72 flows through the upstream pipe 76 and into the casing 12. This exhaust contains fine particles 80, also called particulate matter (PM).

The filter 14 is provided inside the casing 12, and is disposed at a length direction central portion of the casing 12. The filter 14 is what is known as a diesel particulate filter (DPF), and functions to capture the fine particles 80 contained in the exhaust.

The filter 14 may, for example, be formed from a porous ceramic. Inorganic material such as cordierite, alumina, or silicon carbide may be employed as the material of the filter 14. Of these, cordierite is preferable as it does not readily absorb microwaves. An oxidation catalyst 16 such as platinum is supported by the filter 14.

The transmitting antenna 20 is an example of an antenna. The transmitting antenna 20 is disposed at the intake-side of the filter 14 in the casing 12. The receiving antenna 30 is disposed on the exhaust-side of the filter 14 in the casing 12.

The transmitting antenna 20 includes an antenna electrode 22 and a covering member 24. The covering member 24 is an example of a covering layer. The receiving antenna 30 is configured like the transmitting antenna 20 but without a covering member 24, and includes an antenna electrode 32.

Each of the antenna electrodes 22, 32 of the transmitting antenna 20 and the receiving antenna 30 are provided inside the casing 12. Each of the antenna electrodes 22, 32 is formed in a rod shape, and projects from an inner surface of the casing 12 toward a central axis 18 of the casing 12.

The antenna electrode 22 of the transmitting antenna 20 is connected to a microwave generator 86 via a transmitting cable 84. The antenna electrode 32 of the receiving antenna 30 is connected to a microwave detector 90 via a receiving cable 88. The antenna electrode 22 of the transmitting antenna 20 functions to transmit microwaves toward the filter 14. The antenna electrode 32 of the receiving antenna 30 functions to receive microwaves transmitted through the filter 14.

The microwave generator 86 and the microwave detector 90 are connected to a controller 92. A regenerator 94 for regenerating the filter 14, as described below, is also provided to the exhaust purification device 10.

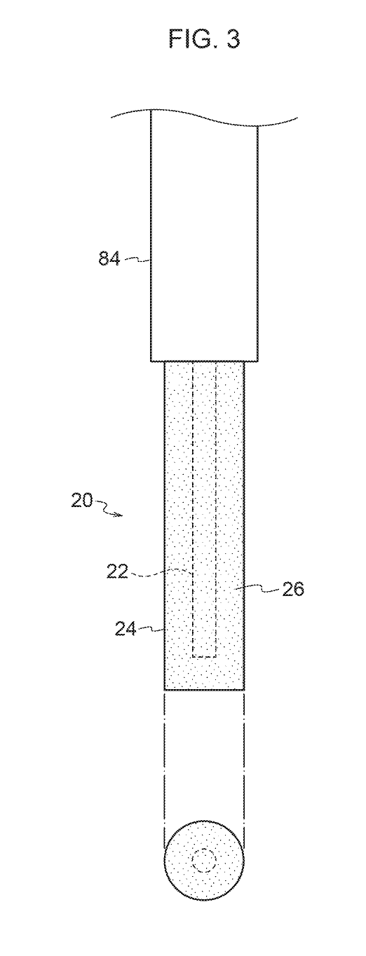

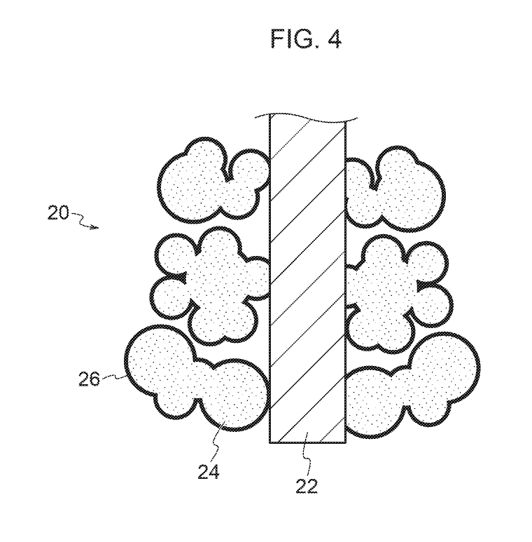

FIG. 3 and FIG. 4 are enlarged illustrations of the transmitting antenna 20 according to the first exemplary embodiment. The covering member 24 provided to the transmitting antenna 20 is formed from an inorganic material and completely covers the antenna electrode 22. The outer profile of the covering member 24 has a substantially circular outline when viewed in cross-section. The covering member 24 may, for example, be formed from a porous ceramic. In cases in which the covering member 24 is formed from a porous ceramic, it is preferable that the pore diameter be small since the fine particles 80 are liable to become trapped therein when the pore diameter is large.

Similarly to the filter 14 described above, an inorganic material such as cordierite, alumina, or silicon carbide may be employed as the material of the covering member 24. Of these, cordierite is preferable as it does not readily absorb microwaves. As conceptually illustrated in FIG. 4, for example, an oxidation catalyst 26 such as platinum is supported by the covering member 24. As illustrated in FIG. 2, the covering member 24 is distinct from the filter 14, and is disposed at an interval from the filter 14.

Explanation follows regarding operation of the exhaust purification device 10 according to the first exemplary embodiment.

Exhaust from the internal combustion engine 72 illustrated in FIG. 1 flows inside the casing 12 illustrated in FIG. 2, where fine particles 80 contained in the exhaust are captured by the filter 14, thereby purifying the exhaust. Purification of the exhaust is continuous, and when a given amount of the fine particles 80 have been captured at the filter 14, the regenerator 94 provided to the vehicle 70 is actuated. The regenerator 94 may, for example, be fuel-injection-type device or a heater-type device.

In cases in which the regenerator 94 is of the fuel-injection-type, fuel is injected into the casing 12 from the regenerator 94. Igniting this fuel heats the filter 14. In cases in which the regenerator 94 is of the heater-type, the filter 14 is heated by the regenerator 94, which is a heater. When the filter 14 is heated in such manner, the oxidation catalyst 16 supported by the filter 14 causes any fine particles 80 captured at the filter 14 to be oxidized (burned off), thereby regenerating the filter 14.

The amount of fine particles 80 captured at the filter 14 is detected in order to determine the timing at which to regenerate the filter 14. Namely, the microwave generator 86 is used to transmit microwaves from the transmitting antenna 20 toward the filter 14. The receiving antenna 30 receives the microwaves transmitted through the filter 14, and the microwaves received by the receiving antenna 30 are detected using the microwave detector 90.

The amount of fine particles 80 captured at the filter 14 is detected (calculated) by the controller 92 based on a difference between the strength of the microwaves transmitted from the microwave generator 86 and the strength of the microwaves detected by the microwave detector 90.

Explanation follows regarding a comparative example, and the issues arising therefrom, as compared to the present exemplary embodiment. In the comparative example, the antenna electrode 22 of the transmitting antenna 20 described above is disposed in a state exposed to the exhaust flow inside the casing 12. Namely, the transmitting antenna 20 is not provided with a covering member 24.

Namely, in a state in which the antenna electrode 22 is exposed, a large amount of fine particles 80 will have become attached to the antenna electrode 22 after an extended period of use. The transmitting antenna 20 is positioned away from the filter 14, at a location where temperature does not readily rise when the filter 14 is heated during regeneration of the filter 14, and so fine particles 80 that have become attached to the antenna electrode 22 are not readily oxidized.

Further, in a state in which the antenna electrode 22 is exposed, the oxidation catalyst 26 is not present on the antenna electrode 22. Thus, in the exposed state of the antenna electrode 22, it is difficult to efficiently oxidize any fine particles 80 that have become attached to the antenna electrode 22 when the filter 14 is heated during regeneration of the filter 14. In particular, the temperature at which the oxidation reaction occurs in the filter 14 is lowered by the oxidation catalyst 16 supported by the filter 14, and so the temperature of the area around the transmitting antenna 20 does not readily rise, making it difficult to oxidize any fine particles 80 attached to the antenna electrode 22.

In such a state in which fine particles 80 are attached to the antenna electrode 22, the strength of the microwaves is changed from an initial state (a state in which no fine particles 80 are attached thereto). Thus, it may not be possible to accurately detect the amount of fine particles 80 captured at the filter 14.

In contrast thereto, in the first exemplary embodiment, the antenna electrode 22 of the transmitting antenna 20 is covered by the covering member 24 formed from inorganic material, and it to this covering member 24 that fine particles 80 become attached. The oxidation catalyst 26 that promotes a reaction to oxidize the fine particles 80 is supported by the covering member 24. Accordingly, when the filter 14 is heated during regeneration of the filter 14, the oxidation catalyst 26 supported by the covering member 24 causes any fine particles 80 attached to the covering member 24 to be efficiently oxidized (burned off) by the heat for regenerating the filter 14.

In particular, the temperature at which the oxidation reaction on the covering member 24 occurs is lowered by the oxidation catalyst 26 being supported by the covering member 24. Any fine particles 80 attached to the covering member 24 are thus suitably oxidized, even when the temperature in the area around the transmitting antenna 20 does not readily rise during regeneration of the filter 14.

Explanation follows regarding the operation and advantageous effects of the first exemplary embodiment.

As described in detail above, in the first exemplary embodiment, the antenna electrode 22 of the transmitting antenna 20 is covered by the covering member 24 formed from inorganic material, and it is to this covering member 24 that fine particles 80 become attached. The oxidation catalyst 26 that promotes a reaction to oxidize the fine particles 80 is supported by the covering member 24. Accordingly, when the filter 14 is heated during regeneration of the filter 14, the oxidation catalyst 26 supported by the covering member 24 enables fine particles 80 attached to the covering member 24 to be efficiently oxidized (burned off) by the heat for regenerating the filter 14.

In particular, the temperature at which the oxidation reaction on the covering member 24 occurs is lowered by the oxidation catalyst 26 being supported by the covering member 24. Any fine particles 80 attached to the covering member 24 are thus able to be suitably oxidized, even when the temperature in the area around the transmitting antenna 20 does not readily rise during regeneration of the filter 14.

The attachment of fine particles 80 to the antenna electrode 22 can thereby be suppressed, enabling the strength of microwaves to be suppressed from changing from an initial state. This enables accurate detection of the amount of fine particles 80 captured by the filter 14, even after an extended period of use.

The oxidation catalyst 26 is not directly applied to the antenna electrode 22. Rather, the oxidation catalyst 26 is supported by the covering member 24 covering the antenna electrode 22. This allows a state in which the oxidation catalyst 26 is retained on the covering member 24 to be maintained, enabling separation of the oxidation catalyst 26 from the antenna electrode 22 to be suppressed compared to when the oxidation catalyst 26 is directly applied to the antenna electrode 22.

Next, explanation follows regarding modified examples of the first exemplary embodiment.

In the first exemplary embodiment, the vehicle 70 is, for example, a truck. However, the vehicle 70 to which the exhaust purification device 10 is applied may be a vehicle other than a truck.

Further, in the first exemplary embodiment, the internal combustion engine 72 is, for example, a diesel engine. However, the internal combustion engine 72 to which the exhaust purification device 10 is applied may be an engine other than a diesel engine. For example, the internal combustion engine 72 may be a gasoline engine.

Further, in the first exemplary embodiment, the covering member 24 is applied to the antenna electrode 22 of the transmitting antenna 20. However, the covering member 24 may be applied to the antenna electrode 32 of the receiving antenna 30, or the covering member 24 may applied to the antenna electrodes 22, 32 of both the transmitting antenna 20 and the receiving antenna 30.

Further, in the first exemplary embodiment, the transmitting antenna 20 is disposed at the intake-side of the filter 14 in the casing 12, and the receiving antenna 30 is disposed on the exhaust-side of the filter 14 in the casing 12. However, for example, the transmitting antenna 20 may be disposed on the exhaust-side of the filter 14 in the casing 12, and the receiving antenna 30 may be disposed at the intake-side of the filter 14 in the casing 12.

Note that the above modified examples of the first exemplary embodiment may also be applied to the second to fourth exemplary embodiments described below.

### Second Exemplary Embodiment

Explanation follows regarding a second exemplary embodiment of technology disclosed herein.

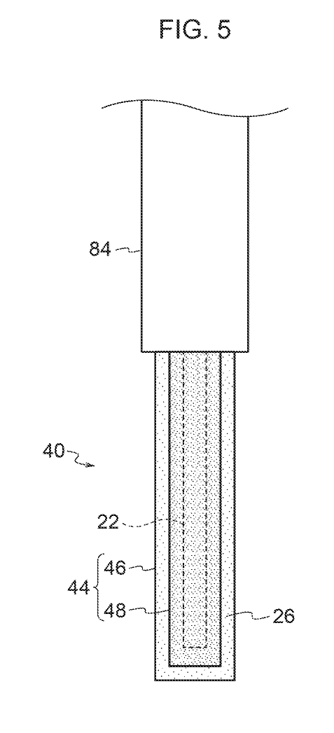

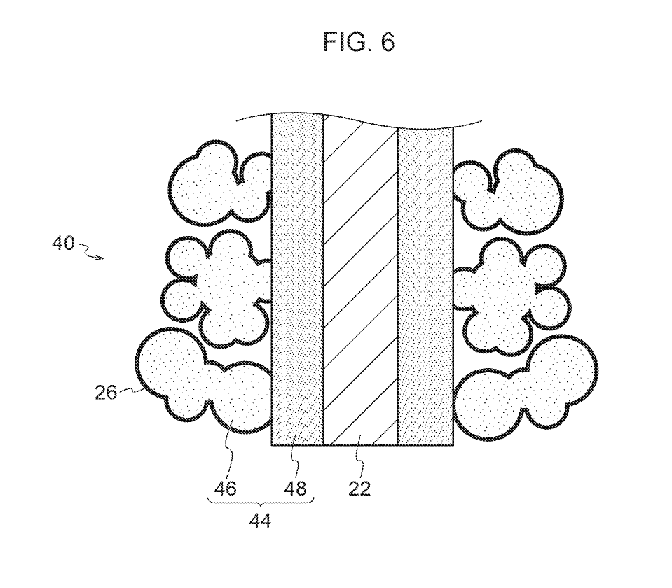

FIG. 5 and FIG. 6 are enlarged illustrations of a transmitting antenna 40 according to the second exemplary embodiment. As illustrated in FIG. 5 and FIG. 6, the transmitting antenna 40 according to the second exemplary embodiment is provided with a covering member 44 in place of the covering member 24 used in the first exemplary embodiment described above (see FIG. 3 and FIG. 4).

The covering member 44 includes a first covering member 46 and a second covering member 48. The first covering member 46 and the second covering member 48 are examples of a first covering layer and a second covering layer, respectively, and are each formed from a porous ceramic. The first covering member 46 and the second covering member 48 are, for example, manufactured independently of one another and then then assembled together into a single unit.

The second covering member 48 is provided between the antenna electrode 22 and the first covering member 46, and completely covers the antenna electrode 22. The first covering member 46 is provided on the outside of the second covering member 48, and completely covers the antenna electrode 22 with the second covering member 48 interposed therebetween.

The second covering member 48 is set with a lower porosity than the first covering member 46, and is formed from a dense ceramic. The first covering member 46 and the second covering member 48 may be respectively set with substantially uniform porosity, or the porosity of the first covering member 46 and the second covering member 48 may be configured so as to gradually decrease on progression from the outside of the first covering member 46 toward the inside of the second covering member 48.

An oxidation catalyst 26 such as platinum is, for example, supported by the first covering member 46. No oxidation catalyst 26 is supported by the second covering member 48. The covering member 44 including the first covering member 46 and the second covering member 48 is distinct from the filter 14 illustrated in FIG. 2, and is disposed at an interval from the filter 14.

Explanation follows regarding the operation and advantageous effects of the second exemplary embodiment, specifically that which differs from the first exemplary embodiment.

In the second exemplary embodiment described above, the covering member 44 includes the second covering member 48, which does not support the oxidation catalyst 26, between the antenna electrode 22 and the first covering member 46. This enables contact reactions such as corrosion caused by contact between the oxidation catalyst 26 and the antenna electrode 22 to be suppressed.

Further, the covering member 44 that includes the first covering member 46 and the second covering member 48 is distinct from the filter 14 illustrated in FIG. 2, and is disposed at an interval from the filter 14. This enables a reduction in the volume of the filter 14 to be suppressed, as compared, for example, to a structure in which the covering member 44 is incorporated into the filter 14. This ensures that the filter 14 is able to capture a given amount of fine particles 80.

Further, the second covering member 48 is set with a lower porosity than the first covering member 46, and is formed from a dense ceramic. Accordingly, since the pores in the second covering member 48 have small diameters, fine particles 80 can be suppressed from becoming trapped in the second covering member 48 not supporting the oxidation catalyst 26.

Further, the covering member 44 is distinct from the filter 14 illustrated in FIG. 2. Accordingly, both the filter 14 and the covering member 44 can be more easily manufactured since there is no need for the filter 14 to incorporate a covering layer that does not support the oxidation catalyst 26.

### Third Exemplary Embodiment

Explanation follows regarding a third exemplary embodiment of technology disclosed herein.

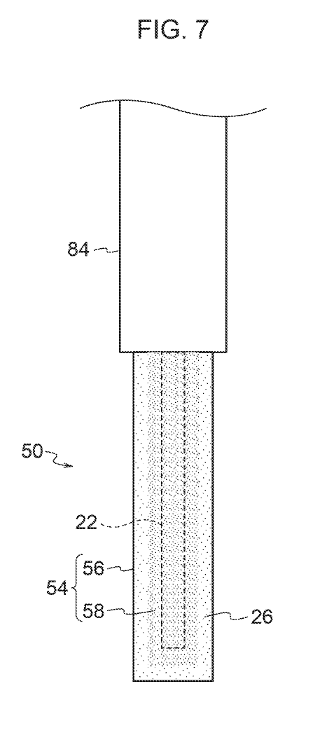

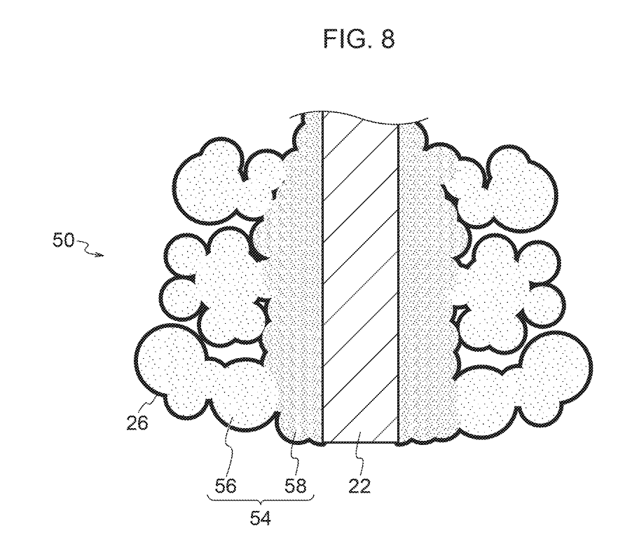

FIG. 7 and FIG. 8 are enlarged illustrations of a transmitting antenna 50 according to the third exemplary embodiment. As illustrated in FIG. 7 and FIG. 8, the transmitting antenna 50 according to the third exemplary embodiment is provided with a covering member 54 in place of the covering member 24 used in the first exemplary embodiment described above (see FIG. 3 and FIG. 4).

The covering member 54 includes a first covering layer 56 and a second covering layer 58. The first covering layer 56 and the second covering layer 58 are formed as a single unit, and are each formed from a porous ceramic. The second covering layer 58 is provided between the antenna electrode 22 and the first covering layer 56, and completely covers the antenna electrode 22. The first covering layer 56 is provided on the outside of the second covering layer 58, and completely covers the antenna electrode 22 with the second covering layer 58 interposed therebetween.

The second covering layer 58 is set with a lower porosity than the first covering layer 56, and is formed from a dense ceramic. The first covering layer 56 and the second covering layer 58 may be respectively set with substantially uniform porosity, or the porosity of the first covering layer 56 and the second covering layer 58 may be configured so as to gradually decrease on progression from the outside of the first covering layer 56 toward the inside of the second covering layer 58.

An oxidation catalyst 26 such as platinum is, for example, supported by the first covering layer 56. No oxidation catalyst 26 is supported by second covering layer 58. The covering member 54 including the first covering layer 56 and the second covering layer 58 is distinct from the filter 14 illustrated in FIG. 2, and is disposed at an interval from the filter 14.

Explanation follows regarding the operation and advantageous effects of the third exemplary embodiment, specifically that which differs from the first exemplary embodiment.

In the third exemplary embodiment described above, the covering member 54 includes the second covering layer 58, which does not support the oxidation catalyst 26, between the antenna electrode 22 and the first covering layer 56. This enables contact reactions such as corrosion caused by contact between the oxidation catalyst 26 and the antenna electrode 22 to be suppressed.

Further, the covering member 54 that includes the first covering layer 56 and the second covering layer 58 is distinct from the filter 14 illustrated in FIG. 2, and is disposed at an interval from the filter 14. This enables a reduction in the volume of the filter 14 to be suppressed, as compared, for example, to a structure in which the covering member 54 is incorporated into the filter 14. This ensures that the filter 14 is able to capture a given amount of fine particles 80.

Further, the second covering layer 58 is set with a lower porosity than the first covering layer 56, and is formed from a dense ceramic. Accordingly, since the pores in the second covering layer 58 have small diameters, fine particles 80 can be suppressed from becoming trapped in the second covering layer 58 not supporting the oxidation catalyst 26.

Further, the covering member 54 is distinct from the filter 14 illustrated in FIG. 2. Accordingly, both the filter 14 and the covering member 54 can be more easily manufactured since there is no need for the filter 14 to incorporate a covering layer that does not support the oxidation catalyst 26.

Further, the first covering layer 56 and the second covering layer 58 are formed as a single unit. This enables cost to be reduced since the both the number of components and the number of steps for assembly can be reduced.

### Fourth Exemplary Embodiment

Explanation follows regarding a fourth exemplary embodiment of technology disclosed herein.

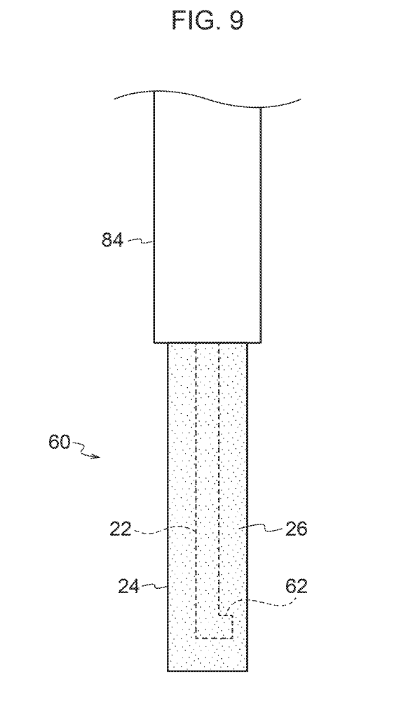

FIG. 9 is an enlarged illustration of a transmitting antenna 60 according to the fourth exemplary embodiment. As illustrated in FIG. 9, the structure of the transmitting antenna 60 according to the fourth exemplary embodiment is modified as follows, as compared to the transmitting antenna 20 according to the first exemplary embodiment described above (see FIG. 3).

Namely, a leading end of the antenna electrode 22 of the transmitting antenna 60 according to the fourth exemplary embodiment is formed with a hook shaped retention portion 62. The retention portion 62 catches on the covering member 24 in the length direction of the antenna electrode 22 such that the covering member 24 is retained on the antenna electrode 22.

Thus forming the antenna electrode 22 with the retention portion 62 enables the covering member 24 to be retained on the antenna electrode 22 with a simple configuration.

Note that the retention portion 62 may be formed in any shape, so long as the covering member 24 is retained on the antenna electrode 22.

The retention portion 62 may also be applied to the transmitting antennas 40, 50 of the second and third exemplary embodiments described above (see FIG. 5 and FIG. 7).

Explanation has been given regarding first to a fourth exemplary embodiments of technology disclosed herein. However, the technology disclosed herein is not limited to the above configurations, and obviously various other modifications may be implemented within a range not departing from the spirit of the present disclosure.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An antenna, comprising:
an antenna electrode that transmits or receives microwaves; and
a covering layer that supports an oxidation catalyst, that is formed from an inorganic material, and that covers the antenna electrode.

2. The antenna of claim 1, further comprising:
a first covering layer that is configured by the covering layer; and
a second covering layer that is provided between the antenna electrode and the first covering layer, that is formed from a dense ceramic, and that covers the antenna electrode.

3. The antenna of claim 2, wherein:
the first covering layer and the second covering layer are formed from a porous ceramic; and
the second covering layer has a lower porosity than the first covering layer.

4. The antenna of claim 2, wherein an oxidation catalyst is not supported by the second covering layer.

5. The antenna of claim 1, wherein a material of the covering layer is cordierite.

6. A covering member for covering an antenna electrode that transmits microwaves toward a filter at which fine particles contained in exhaust from an internal combustion engine are captured, or that receives microwaves transmitted through the filter, the covering member comprising:
a covering layer that supports an oxidation catalyst and that is formed from an inorganic material.

7. The covering member of claim 6, further comprising:
a first covering layer that is configured by the covering layer; and
a second covering layer that is provided between the antenna electrode and the first covering layer, that is formed from a dense ceramic, and that covers the antenna electrode.

8. The covering member of claim 7, wherein:
the first covering layer and the second covering layer are formed from a porous ceramic; and
the second covering layer has a lower porosity than the first covering layer.

9. The covering member of claim 7, wherein an oxidation catalyst is not supported by the second covering layer.

10. The covering member of claim 6, wherein a material of the covering layer is cordierite.

11. An exhaust purification device, comprising:
a casing inside which exhaust from an internal combustion engine flows;
a filter that is provided inside the casing, and at which fine particles contained in the exhaust are captured; and
an antenna that is provided inside the casing, the antenna including an antenna electrode that transmits microwaves toward the filter or that receives microwaves transmitted through the filter, and including a covering layer that supports an oxidation catalyst, that is formed from an inorganic material, and that covers the antenna electrode.

12. The exhaust purification device of claim 11, wherein the antenna further includes a covering member having:
a first covering layer that is configured by the covering layer; and
a second covering layer that is provided between the antenna electrode and the first covering layer, that is formed from a dense ceramic, and that covers the antenna electrode.

13. The exhaust purification device of claim 12, wherein:
the first covering layer and the second covering layer are formed from a porous ceramic; and
the second covering layer has a lower porosity than the first covering layer.

14. The exhaust purification device of claim 12, wherein an oxidation catalyst is not supported by the second covering layer.

15. The exhaust purification device of claim 12, wherein the covering member is disposed at an interval from the filter.

16. The exhaust purification device of claim 11, wherein a material of the covering layer is cordierite.

17. The exhaust purification device of claim 11, wherein the antenna is disposed at an intake side of the filter in the casing.

18. The exhaust purification device of claim 11, wherein the filter supports an oxidation catalyst.
